(19) United States
(12) Patent Application Publication
(10) Pub. No.: US 2010/0102789 A1
(43) Pub. Date: Apr. 29, 2010

(54) SWITCH-MODE POWER SUPPLY METHOD AND APPARATUS USING SWITCH-NODE FEEDBACK

(75) Inventor: Mitch Randall, Boulder, CO (US)

Correspondence Address: COCHRAN FREUND & YOUNG LLC, 2026 CARIBOU DR, SUITE 201, FORT COLLINS, CO, 80525, US

(73) Assignee: WILDCHARGE, INC., Boulder, CO (US)

(21) Appl. No.: 12/607,058

(22) Filed: Oct. 27, 2009

Related U.S. Application Data
(60) Provisional application No. 61/108,784, filed on Oct. 27, 2008.

(51) Int. Cl. G05F 1/10

(52) U.S. Cl. 323/282

(57) ABSTRACT

Example switch mode power supplies, including buck converters, with indirect, switch-mode feedback for pulse width modulation and duty cycle control are described and shown. Non-idealities are corrected with several example compensation methods and apparatus, including current sense and corresponding voltage adjustment.

### CROSS-REFERENCE TO RELATED APPLICATIONS

This invention claims the benefit of U.S. provisional application No. 61/108,784, filed on Oct. 27, 2008.

### BACKGROUND OF THE INVENTION

### State of the Prior Art

Switch-mode power supplies are used to convert electrical power of a given voltage to a different desired voltage. Given the pervasive use of power supplies for a broad range of electronic devices, it is advantageous to minimize their cost and complexity, particularly, but not exclusively, for price competitive consumer electronic products.

In general, voltage outputs of switch-mode power supplies are controlled by periodically turning switches that are connected to the source of power on and off periodically, and, for a given input voltage, the duty cycle (relating the on time to the period) is directly related to the output voltage. Therefore, switch mode power supplies use one or more active devices as switches along with some kind of on-off control to turn the switch or switches on and off with a desired duty cycle to produce a desired output voltage. Such duty cycle controllers or control circuits, which generate the on-off signals to control the switch or switches are called pulse width modulation (PWM) controls or controllers. Ideally, these switches are digital in the sense that they switch almost instantaneously between full on and full off and vice versa. There are a host of canonical circuit topologies known to persons skilled in the art and available publicly to achieve various power supply characteristics. Good PWM control circuits can be quite complex due to the number of functions and details they entail, including, for example, triangle or other waveform generation, comparison, loop stability, cycle-by-cycle current limiting, slope compensation, lock-out, and other considerations. However, integrated circuit PWM controllers are readily available commercially that take care of these functions and complexities.

A less complicated PWM control technique called hysteretic control uses the output ripple (small periodic oscillations in the output voltage) to create the PWM drive to switch to control the duty cycle, thus output voltage. This hysteretic technique simplifies the PWM function by eliminating the triangle or other waveform generator and some other complexities, but it introduces other problems. For example, the output voltage necessarily has voltage ripple, which is a requirement of the feedback technique, and the switching frequency is greatly dependent on the load.

The foregoing examples of related art and limitations are intended to be illustrative, but not exclusive or exhaustive of the subject matter. Other aspects and limitations of the related art will become apparent to those skilled in the art upon a reading of the specification and a study of the drawings.

### BRIEF DESCRIPTION OF THE DRAWINGS

The accompanying drawings, which are incorporated herein and form a part of the specification, illustrate some, but not the only or exclusive, example embodiments and/or features. It is intended that the embodiments and figures disclosed herein are to be considered illustrative rather than limiting.

In the drawings:

FIG. 1 is a block diagram of an example switch-mode buck converter with switch-node feedback;

FIG. 2 is a schematic circuit diagram of an example switch-mode buck converter with switch-mode feedback;

FIG. 3 is a block diagram similar to FIG. 1, but with an added capacitance to mitigate undamped ringing;

FIG. 4 is a schematic circuit diagram similar to FIG. 2, but with the added capacitance to mitigate undamped ringing and not including a capacitance component used in the FIG. 2 example for creating a triangular waveform to the comparator;

FIG. 5 is a schematic diagram similar to FIG. 4, but with a Schmidt trigger circuit instead of the comparator circuit in FIG. 4; and

FIG. 6 is a schematic diagram similar to FIG. 2, but with an added current sense circuit and compensating input voltage to the comparator.

### DETAILED DESCRIPTION OF EXAMPLE EMBODIMENTS

The most common switch mode power supplies, converters, or regulators that use pulse width modulation (PWM) to control duty cycle of one or more active switches to control voltage output are switched inductor converters, including buck converters, boost converters, and buck-boost converters (also commonly called inverters). Buck converters reduce the input voltage in direct proportion to the duty cycle (the ratio of a switch conductive or “on” time to total switching period), whereas the output voltage of a boost converter is always greater than the input voltage. A buck-boost output voltage is inverted, but it can be greater than, equal to, or less than the magnitude of its input voltage. In all conventional buck, boost, and buck-boost converters, the input, the output, and the ground all come together at one point or node, but one of three (input, output, or ground) passes through an inductor on the way to the node where they all come together, and the other two pass through switches, at least one of which must be an active switch and the other switch can be a diode. The active switch is controlled (e.g., turned on and off) by pulse width modulation (PWM), which sets the duty cycle, and a feedback control loop is used to regulate the output voltage by modulating the pulse width to vary the duty cycle to compensate for variations in input voltage. In the examples described herein, the feedback is obtained from the node that connects the active switch to the inductor, is called the switch node.

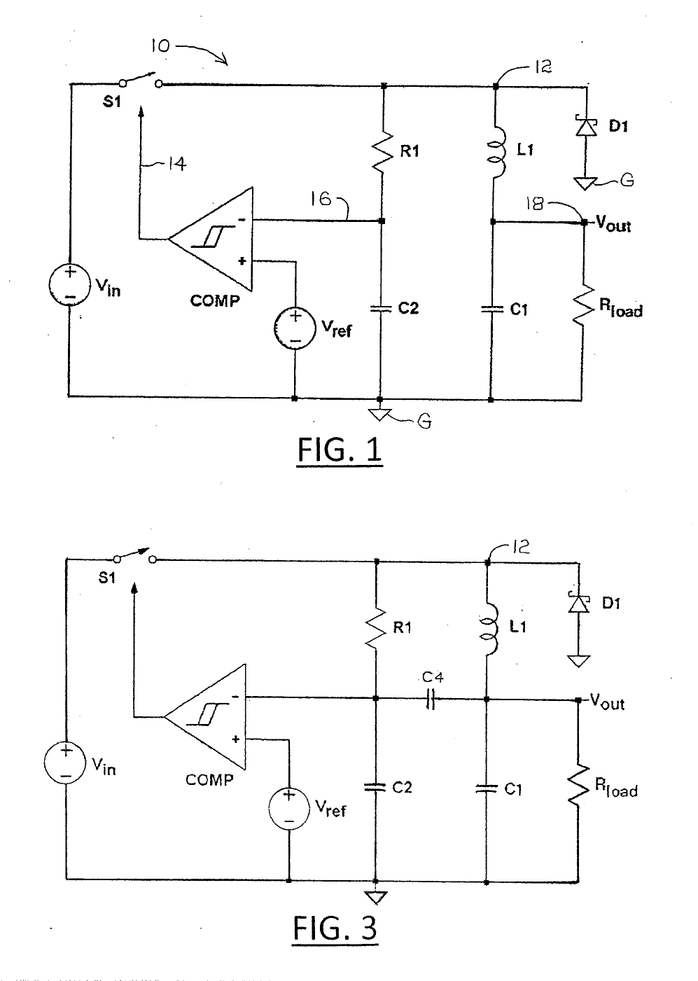

A block diagram of an example buck converter circuit 10 utilizing switch-node feedback for pulse width modulation (PWM) to control duty cycle, thus output voltage, is shown in FIG. 1. This buck converter circuit 10, as well as the other circuits shown and described herein, are example, but not the only possible, implementations that demonstrate features and principles of switch-node feedback for switch-mode power supplies, converters, and regulators. Therefore, this description will proceed with reference to the example circuits and implementations shown in the FIGS. 1-6, but with the understanding that the inventions recited in the claims below can also be implemented in myriad other switch-mode power supply, converter, and regulator circuits and topologies, once the principles are understood from the examples, descriptions, and explanations herein, and that some, but not all, of such other implementations, variations, and enhancements are also described or mentioned below. Also, it is easiest and most natural to discuss the operation of the example circuits and implementations with the assumption that the load current is high enough so that the example converters are operating in continuous conduction mode, i.e., that the inductor current does not go to zero between switching cycles. However, the principles and applications of switch-node feedback discussed and explained herein are also applicable to discontinuous conduction mode operation, i.e., where the inductor current does go to zero during part of the switching cycle, and discontinuous conduction mode does not pose a limitation to this method or technique.

Referring now primarily to the example buck converter 10 in FIG. 1, the buck converter circuit elements include the input Vᵢₙ, the output Vₒᵤₜ, the ground G, the energy transfer inductor L1, the active switch S1, and the diode D1. An output capacitor C1 is usually included in a buck converter (shown in the example buck converter 10 in FIG. 1 across the output in parallel to the load R_{load}) to smooth out the current changes from the inductor L1 into a stable voltage at Vₒᵤₜ and to minimize voltage overshoot, in which output voltage overshoots the regulated value when a full load is suddenly removed from the output. C1 also minimizes voltage ripple and ringing at the output. Input capacitors (not shown) and other components can also be included for various design needs and parameters, as is known to persons skilled in the art, thus need not be described here.

Essentially, the buck converter operates by closing the active switch S1 to connect the input voltage Vᵢₙ to the inductor L1 to store energy in the inductor L1 as current flows to the load R_{load}, and then, when the active switch S1 is opened, the energy stored in the inductor L1 discharges into the load R_{load}, where it performs work or creates heat. While the active switch S1 is closed, there is a voltage (Vᵢₙ−Vₒᵤₜ) across L1, the current rises linearly, a magnetic field builds in L1 (storing energy), and the diode D1 is reverse biased (turned off), thus prevents current flow from the input, through D1 to ground G so that the current flows through the load R_{load}. However, when the active switch S1 is opened, the applied voltage Vᵢₙ is removed, the magnetic field of L1 collapses, reversing the voltage and releasing the energy to continue the current flow, which falls linearly as the energy depletes, and the now forward biased (thus turned on) diode D1 provides a current path (closed circuit) for the L1 induced current to flow through the load R_{load}. Of course, the more time the active switch is turned on during each cycle, the more energy will be stored in the inductor L1 during each cycle, and the higher the output voltage Vₒᵤₜ will be. Therefore, as mentioned above, the higher the duty cycle (ratio of time the switch is one to the total time of a cycle period), the higher the output voltage Vₒᵤₜ will be. Likewise, the lower the duty cycle, the lower the output voltage Vₒᵤₜ will be. Also, if the input voltage Vᵢₙ varies for a given duty cycle, the energy transferred into the inductor L1 will vary accordingly, so the energy discharged by the inductor L1 to the load R_{load} will also vary, causing a comparable variations in the output voltage Vₒᵤₜ. Therefore, in order to maintain a constant output voltage Vₒᵤₜ for a given load R_{load} when the input voltage Vᵢₙ decreases, the duty cycle (ratio of time the active switch S1 is on in a cycle period) can be increased to maintain the same level of energy transferred into the inductor L1 in each cycle in spite of the lower input voltage Vᵢₙ. Likewise, in order to maintain a constant output voltage Vₒᵤₜ for a given load R_{load} when the input voltage Vᵢₙ increases, the duty cycle can be decreased. Also, a variation in the load R_{load} will change the voltage drop across the load R_{load} and affect the current flow, thus energy transfer into and out of the inductor L1, causing variation in the output voltage Vₒᵤₜ. Consequently, the duty cycle may have to be varied to maintain a constant output voltage Vₒᵤₜ as variations in the load R_{load} occur.

In the example buck converter 10 shown in FIG. 1, the active switch S1 is turned on and off by a pulse width modulated switch control signal 14 from an inverting comparator COMP, which provides the duty cycle or timing with which the active switch S1 is turned on and off. In order to maintain a constant desired output voltage Vₒᵤₜ in spite of variations in input voltage Vᵢₙ and other variations, a feedback indicative of the output voltage Vₒᵤₜ is applied to the comparator COMP to cause it to adjust the pulse width modulation (PWM) of the switch control signal 14 to create a duty cycle adjustment as needed to correct for any changes in the output voltage Vₒᵤₜ from the desired output voltage Vₒᵤₜ. In this example, the output voltage feedback is obtained indirectly, from the switch node 12, instead of directly from the output voltage node 18, which has several advantages. For example, the on and off state continues at a fairly fixed frequency that depends little on the output load R_{load} or on the load current, and the circuit can still be relatively simple.

As mentioned above, the node 12, which connects the active switch S1 to the energy transfer inductor L1 is called the switch node. The pulse width modulation (PWM) control of the active switch S1 to control the duty cycle, thus the output voltage Vₒᵤₜ, is provided in this example buck converter 10 by an inverting comparator COMP, as indicated diagrammatically by the output 14 to the active switch S1. As also indicated by the connection 16 of the inverting input (−) of the comparator COMP to the switch node 12 via the resistor R1, the feedback for the comparator COMP to regulate the output voltage Vₒᵤₜ is obtained from the switch node 12. When the inverting comparator COMP compares the voltage on the inverting input (−) to a reference voltage V_{ref} connected to the non-inverting (+) input of the comparator COMP, and it outputs an on signal to the switch S1 when the inverting input (−) voltage is lower than V_{ref} and outputs an off signal when the inverting input (−) voltage is lower than V_{ref}, thereby completing a control loop. A capacitance, represented diagrammatically by the capacitor C2 in FIG. 1, between the inverting input (−) of the comparator COMP and a low impedance point, such as the ground G and/or the load R_{load}, charges and discharges to form a time-varying voltage substantially similar to a sawtooth waveform, and it slows the rate at which the feedback voltage changes on the inverting input (−) of the comparator COMP in response to the voltage changes at the switch-node 12 as applied to the inverting input (−) through the feedback resistor R1. This arrangement allows the switching frequency to be set by appropriate choice of components R1 and C2. Hysteresis in the comparator COMP ensures bistable operation such that the voltage across C2 is constantly increasing and decreasing between two levels. The values of the feedback resistance R1, the capacitance C2, and the hysteresis, together, control the frequency of the bistable oscillations for a given input and output voltage. Assuming continuous conduction mode operation, the voltage at the switch node 12 toggles between Vᵢₙ and ground G at that switching frequency, regardless of variations in current through the load R_{load}. Therefore, the comparator COMP outputs on and off drive signals to the switch S1 at a fixed frequency that depends little on the output load R_{load} and is fairly immune to variations in load current.

The duty cycle of the drive signal 14 from the comparator COMP will be that required to create an average voltage equal to the reference voltage V_{ref} across C1, i.e., between the switch node 12 and ground G. The average voltage across the capacitor C2 is the same as the average voltage at the switch node 12, because the average current in the capacitor C2 has to be zero, and ideally, assuming the comparator COMP does not require any current so that the only current that flows through the feedback resistor R1 charges and discharges the capacitor C2, the average voltage across the feedback resistor R1 is also zero. Further, ideally, the average voltage across the inductor L1 has to be zero, so the output voltage Vₒᵤₜ is ideally equal to the average voltage at the switch node 14. Consequently, by these equivalencies, the output voltage Vₒᵤₜ, like the voltage at the switch node 12, will also be equal to the reference voltage V_{ref}.

In practice, of course, inductors and comparators are not ideal, so the output voltage Vₒᵤₜ will not be exactly equal to the voltage across the capacitor C2. For example, leakage current in the comparator COMP will cause a slight voltage drop across the feedback resistor R1, thus biasing the equivalence. Also, resistance in the inductor L1 will create droop in the output voltage Vₒᵤₜ, which does not affect the voltage at the switch node 12, thus will not be detected or cause duty cycle correction or compensation by the pulse width modulation of the COMP. Other non-ideal losses or leakages might also bias the equivalences described above. However, there are ways to mitigate and/or compensate for such affects due to non-idealities, which are known to persons skilled in the art to help achieve acceptable operation of this kind of power supply or converter for many applications and performance specifications. For example, but not for limitation, an inductor with a specified series resistance that will keep the resulting droop within tolerable specifications for a particular application can be selected and used for the energy transfer inductor L1. Also, for example, but not for limitation, a compensatory signal can be provided to the comparator COMP based on measured output current so that the inherent droop in the output voltage Vₒᵤₜ from resistance in the induction L1 can be cancelled by a corresponding rise in the average voltage at the switch node 12. These and other mitigations and compensations can be used, if necessary, to take advantage of the benefits of switch node feedback principles and/or example implementation described herein.

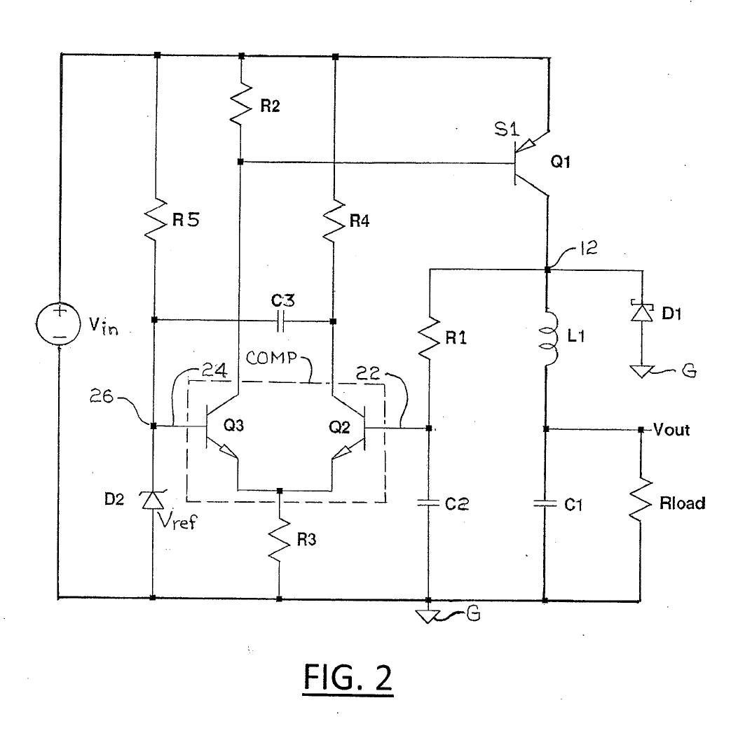

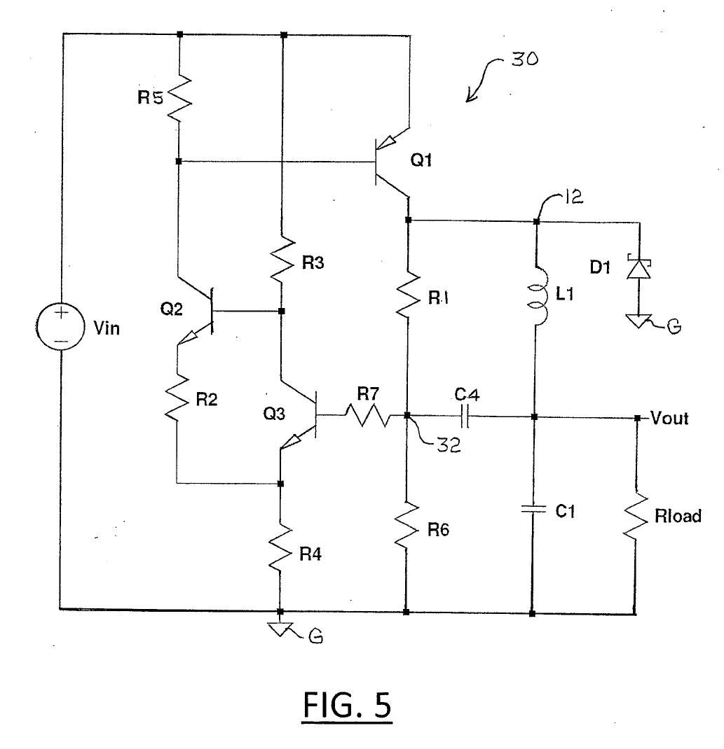

As mentioned above, the example buck converter 10 with switch-node feedback shown in FIG. 1 and described above is a block diagram, which can be implemented in a variety of ways. The circuit diagram in FIG. 2 shows one fairly simple example of a switch-mode buck converter 20 with a switch-node feedback PWM control implementation, where the transistor Q1 forms the active switch (S1 in FIG. 1), and the transistors Q2 and Q3 in a differential configuration form the comparator (COMP in FIG. 1). The inverting input 22 of the comparator is at the base of Q2, and the non-inverting input 24 is at the base of Q3. Therefore, the base of Q2 (the inverting input 22) is connected to the switch-node 12 (i.e., the node where the collector of the active switch Q1 connects to the energy transfer inductor L1), and the base of Q3 (the non-inverting input 24) is connected to the cathode of a zener diode D2, which functions as a reference voltage V_{ref}. The value of this V_{ref} can be set at any desired level to produce a desired output voltage Vₒᵤₜ level, which may be equal to V_{ref} as explained below. A circuit can also be configured to provide a Vₒᵤₜ that is different than the V_{ref}, for example with resistors, voltage dividers, or other multipliers, as shown in the FIG. 5 example below.

Like the FIG. 1 example 10, the capacitor C2 is provided across the inverting input 22, and the output voltage Vₒᵤₜ is ideally equal to the average voltage at the switch-node 12, which is equal to the average voltage across the capacitor C2, which, with the pulse width modulation (PWM) provided by the comparator, is maintained the same as the reference voltage V_{ref}, as explained above. Therefore, as also explained above for the example 10 of FIG. 1, the feedback for modulating the pulse width of the on-off control signal for the switch Q1 to provide a duty cycle that maintains the output voltage Vₒᵤₜ at a desired level is obtained at the switch-node 12, and the comparator COMP works to maintain the average voltage of C2, which is equal to the average voltage at the switch-node 12, at the same level as the reference voltage V_{ref}.

Essentially, when the voltage across the capacitor C2 drops below the low threshold set by the voltage on the base of Q3, the COMP switches on, and current flows through Q3 to drive the base of the switch Q1 to turn Q1 on. When the switch Q1 is turned on, the switch-node 12 voltage goes high, substantially equal to the input voltage Vᵢₙ, and current flows from the input, through the switch Q1 and through the energy transfer inductor L1 to the load R_{load}. The voltage across the capacitor C2 follows the switch-node 12 voltage and increases approximately linearly. Eventually, when the voltage across the capacitor C2 reaches the high threshold set by the voltage at the base of Q3, the COMP turns off, i.e., Q2 turns on and Q3 turns off, so current ceases following through Q3 to drive the base of the switch Q1, and flows through Q2 instead. With no current flowing through Q3 to drive the base of the switch Q1, the switch Q1 turns off, and the switch-node 12 voltage drops to a diode drop below ground G as the current induced by the inductor flows through the diode D1 and through the load R_{load}. With that voltage drop, there is a negative voltage across R1, which gives rise to a current that makes the voltage on C2 decrease. When the voltage of C2 falls again to the threshold voltage set by the voltage on the base of Q3, then Q3 turns on as a result of V_{ref} on the base of Q3 then being higher than the voltage at the emitter of Q3, and Q2 turns off. The turned on Q3 again turns on the switch Q1, and the cycle repeats.

The resistor R2 is provided to drain the charge stored in the base-emitter junction of the switch Q1 when Q3 turns off, so that Q1 turns off quickly. The resistor R3 sets the operating current of the COMP, which will go through either Q2 or Q3, depending on which one is turned on.

Hysteresis, which defines how far the voltage on C2 ramps up and down chasing the switching threshold, is created by positive feedback from a capacitive coupling between the Q2 output and the zener diode D2, which provides the reference voltage V_{ref} on the base 24 of Q3. In the example buck converter 20 circuit shown in FIG. 2, the capacitive coupling is provided by the capacitor C3 connected between the collector of Q2 and the non-inverting input 24 on the reference node, i.e., the node connecting the V_{ref} of the zener diode D2 to the base of Q3. When Q2 is turned on and current flows through R4, a voltage is developed at R4. That voltage is capacitively coupled by C3 to the reference node 26 at the non-inverting input 24 on the base of Q3, where it works against the inherent dynamic resistance of the zener diode D1 to create a tiny square wave at the switching frequency riding on the reference voltage V_{ref} provided by the zener diode D1 as Q2, thus the voltage across R4 applied to the reference node 26, turns on and off. This positive feedback from Q2 to the reference node 26 and base of Q3 creates the hysteresis for the comparator voltage thresholds that result in bistable operation of the comparator COMP and switching Q1 on and off at a fixed frequency with little, if any, dependence on the load R_{load} or on the load current, because the cycling of voltage at C2, thus cycling of Q2, is caused by voltage changes at the switch-node 12 and not by current flowing to or through the load. Therefore, the voltage at C2 ramps up and down the amount and frequency of the tiny square wave riding the V_{ref} on the base of Q3, chasing the ever-toggling threshold of the comparator COMP.

As mentioned above for the FIG. 1 example 10, because the voltage across the capacitor C2 is constrained to lie between the high and low hysteretic thresholds of the comparator, closed loop control of the average voltage across the capacitor C2 is inherently stable. At the same time, the output voltage Vₒᵤₜ is controlled indirectly, by feedback from the switch node 12, instead of directly from the output voltage Vₒᵤₜ.

Although the average output voltage Vₒᵤₜ is theoretically equal to V_{ref}, as explained above, it can vary instantaneously from V_{ref}. Capacitor C1 and inductor L1 form an LC low-pass filter with damping factor being dependent on the load R_{load}. In some cases, the dynamic impedance of the load may be very high, for example, when the load has a large inductive component or drives a circuit that draws a constant current, which can allow excessive and/or undesired ringing at the output. Such undesired effects can be mitigated by the addition of capacitance coupling from the output to the summing junction (the inverting input of the comparator) as shown, for example, by the capacitor C4 in FIG. 3, which, except for the addition of the capacitor C4, is the same block diagram of the example buck converter 10 as shown in FIG. 1. With this addition of capacitance coupling C4, ringing at the output will feed back into the PWM control, causing opposing adjustments to the switch drive. In this variation, the capacitance across the inverting input (−) of the comparator COMP, which charges and discharges to form the time-varying voltage, is provided by the combination of C2 and the newly added C4.

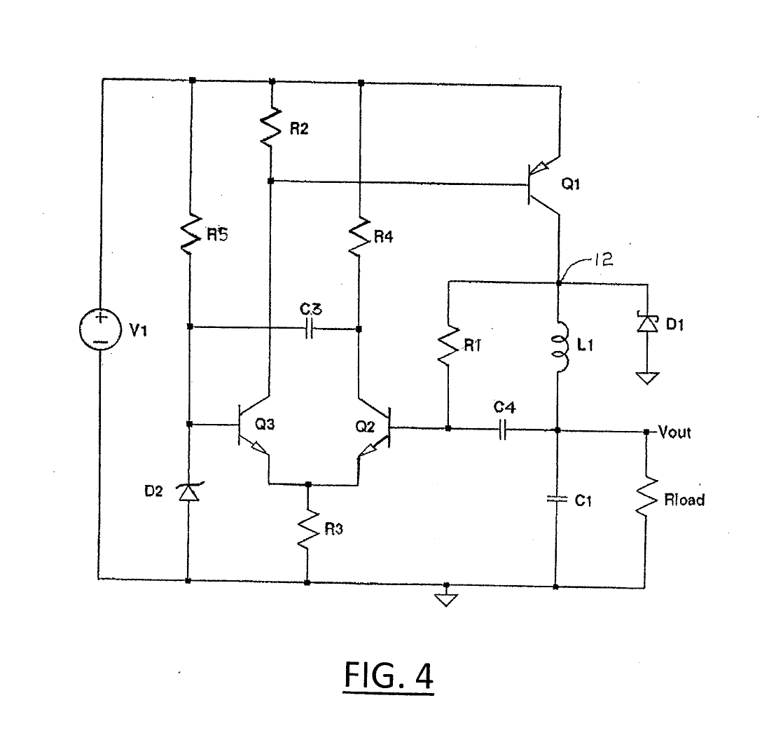

In some case, the capacitor C2 can be eliminated, as illustrated, for example, in FIG. 4, which is the same buck converter circuit as the example 20 in FIG. 2, except for the addition of C4 and elimination of C2. In this example in FIG. 4, the capacitance across the inverting input (at the base of Q2) of the comparator COMP, which charges and discharges to form the time-varying voltage, is provided by C4.

The non-idealities of the example buck converters with switch-node feedback shown in FIGS. 2-4 can be mitigated or provided with compensations as explained above for the example 10 in FIG. 1.

The hysteretic comparator for use in switch-mode power supplies using switch-node feedback can also be provided in other ways, for example, with a Schmidt trigger, as illustrated in an alternate embodiment in FIG. 5. The example buck converter 30 circuit shown in FIG. 5 is similar to the example buck converter circuit shown in FIG. 4, but with a Schmidt trigger formed by transistors Q2 and Q3 instead of the comparator COMP in the FIG. 4 example. The feedback in this example buck converter 30 is still obtained from the switch-node 12, as described above, but the reference voltage for output voltage Vₒᵤₜ regulation is the emitter-base voltage of Q3 plus the hysteresis voltage developed across R4. Also, as in the FIG. 4 example, the capacitance across the inverting input of the Schmidt trigger comparator in FIG. 5 is provided by the capacitor C4 between the inverting input and the load R_{load}. In this embodiment, the comparator with hysteresis is formed by Q2, Q3, R2, R3, and R4. When Q3 is on, the voltage at the emitter of Q2 is low, and hence the current through R2 is low. The low current through R2 causes the voltage drop across R4 to be low, and therefore the threshold at the base of Q3 is also low. When the voltage at summing junction 32 drops below the low threshold, Q3 turns of, which in turn causes the voltage on the base of Q2 to be large. As a consequence, the voltage at the emitter of Q2 also becomes large, which results in a high current passing through R2. The high current of R2 flows through R4 developing the “high” voltage across R4, which, in turn, sets the threshold of Q3 to its “high” value. Drive is provided to the switching transistor Q1 whenever the current through R2 is in the “high” state. In this way, the switch-node 12 causes the voltage at summing junction 32 to “chase” the ever-changing threshold at the base of Q3. The Resistor divider formed by R1 and R6 then set the average voltage of the switch-node 12 to be a multiple of the average voltage on the base of Q3, thereby regulating the output Vₒᵤₜ. The voltage at the summing junction 32 formed by R1, R6, R7, and C4 approximates a triangle wave, similar to that described in the example 10 in FIG. 1. The Schmidt trigger (Q2 and Q3) turns on and off at two different threshold levels, the difference of which is defined by the hysteretic voltage developed across R4.

As the voltage at the summing junction 32, which is derived as a predetermined fraction of the voltage of the switch-node, decreases below the lower threshold, the Schmidt trigger turns on, and the current flow through Q2 drives the switch transistor Q1 to turn on. Turning on switch Q1 drives the output of Q1, thus the switch-node 12, to Vᵢₙ, and causes the voltage at the summing junction 32 to increase, which is caused by capacitor C4 charging through resistor R1. The resistors R6 and R7 facilitate setting the output voltage Vₒᵤₜ at a desired level, which may be different than the reference voltage or hysteresis thresholds.

As the voltage at the summing junction 32 increases beyond the upper threshold, the Schmidt trigger turns off, stopping the flow of current through Q2, and thereby removing the drive from the switch transistor Q1. As a result, switch Q1 turns off (speeded by drain of energy through R5), and the voltage at the switch-node 12 goes to a diode drop below ground G. This voltage drop at the switch-node 12, in turn, causes the voltage at the summing junction (the charge in capacitor C4) to decrease. The cycle repeats itself, as explained for previous examples, with the frequency defined by the hysteresis voltage, the Thevenin charging resistance, the value of the capacitor C4, and the supply voltage Vᵢₙ. Also, as in the previous examples, the frequency has little, if any, dependence on the load R_{load} or the load current.

A metal oxide semiconductor field effect transistor (MOSFET) or other kinds of transistors (not shown) can be used for the switch Q1, if desired, instead of the bipolar junction transistors (BJT) shown in the examples, including either the differential pair or other comparator versions or the Schmidt trigger versions described above. In general, modifications of the example circuits to accommodate various silicon switches would be obvious to persons skilled in the art, once they understand the principles of this invention, and such obvious variants are considered to be equivalents within the scope and intent of the invention as defined by the claims below.

A buffer (not shown) can also be placed between the drive signal and the gate of a MOSFET switching device in order to allow the input capacitance of the MOSFET to be charged more quickly than the collector resistor of the previously described examples allow. The increased switching speed reduces switching losses and improves overall converter efficiency.

As mentioned above, non-idealities, mostly resulting from losses in the inductor L1, can result in degradation in the output voltage Vₒᵤₜ regulation against output load, and some, but not necessarily all, relatively simple techniques for reducing these effects and improving output regulation have been discussed above. A non-ideal inductor possesses a non-zero series resistance that introduces a voltage drop across the inductor, and such voltage drop biases the equivalence between output voltage and average voltage at the switch-node upon which this method and apparatus relies for output regulation. As a result, the output voltage will droop according to the product of the inductor series resistance and the load current.

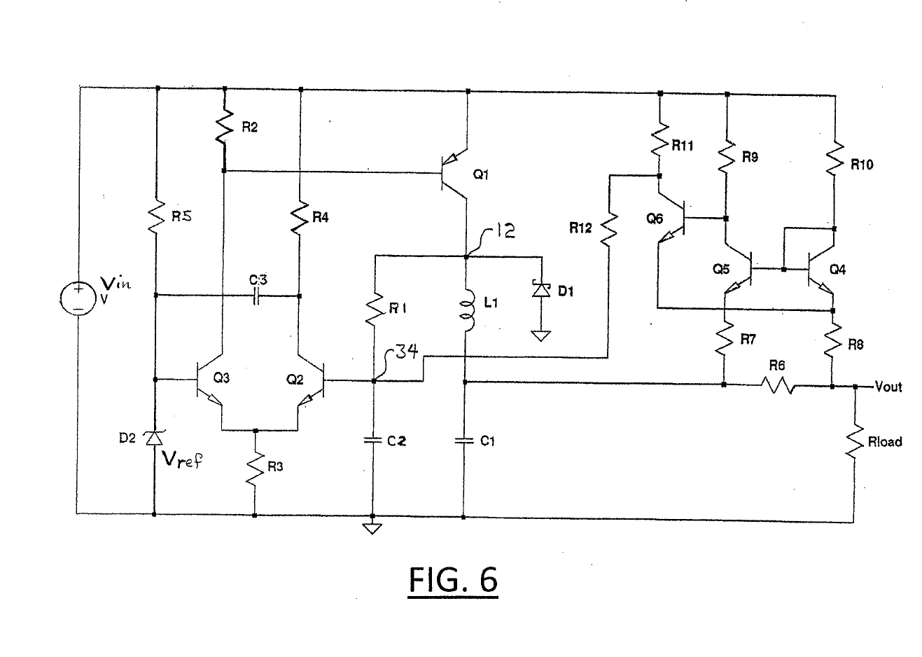

One approach to counteract such droop in voltage output due to inductor series resistance includes the output current sense circuit for injecting a compensating signal to the comparator or Schmidt trigger summing junction, as shown, for example, in FIG. 6. The example buck converter with switch-node feedback shown in FIG. 6 is substantially the same as shown in FIG. 4, but it has a current sense circuit added, which comprises, for example, resistors R6 through R11 and transistors Q4 through Q6. In this example, a voltage is derived across the resistor R11, which is proportional to the output current. This voltage derived across R11 is the output of the current sense circuit. A feedback resistor R12 couples the output of the current sense circuit to the comparator summing junction 34.

When there is little or no output current, the voltage drop across the resistor R11 is small, and the current through resistor R12 is defined by the difference between the output voltage Vᵢₙ and the voltage at the summing junction 34. As the current increases, the voltage drop across resistor R11 increases, lowering the current through R12. The lower current through R12 causes a higher duty cycle at the switch-node 12, thereby increasing the average voltage at the switch-node 12, which, in turn, counteracts the inherent voltage drop in the inductor L1.

The example circuit in FIG. 6 can also be adjusted to compensate for the non-ideal zener diode D2, which provides the reference voltage in the circuit. In practice, the zener diode D2 does not perform ideally, because the shunt current through the zener diode D2 changes with input supply voltage Vᵢₙ. This variation in current results in a variation in the reference voltage V_{ref} at the base of Q3. As a result, the output voltage Vₒᵤₜ increases with increasing input voltage Vᵢₙ. The resistors R11 and R12 can be adjusted so as to cancel this input voltage Vᵢₙ dependence. At the same time, a solution exists so as to allow resistors R11 and R12 to simultaneously compensate for load current droop as explained above. Consequently, the example circuit in FIG. 6 can achieve good output regulation across varying input voltage and load current. The current sensing circuit of FIG. 6 comprises Q4, Q5, Q6, R6, R7, R8, R9, R10. The transistors Q4 and Q5 form a differential amplifier measuring the voltage across R6. The output of the differential amplifier drives R9 and R10. The voltage drops across R9 and R10 will be equal as long as the voltages on the emitters of Q4 and Q5 are equal. When load current flows through R6, the balance is disturbed and Q6 turns on. Current through the emitter of Q6 creates a drop across R8 that tends to restore balance on the emitters of Q4 and Q5. The current required to restore balance is directly proportional to the load current. In this way, the current that flows in the collector of Q6 is proportional to the load current.

While a number of example aspects and implementations have been discussed above, those of skill in the art will recognize certain modifications, permutations, additions, and subcombinations thereof. It is therefore intended that the following appended claims and claims thereafter introduced are interpreted to include all such modifications, permutations, additions, and subcombinations as are within their true spirit and scope.

The words “comprise,” “comprises,” “comprising,” “composed,” “composes,” “composing,” “include,” “including,” and “includes” when used in this specification, including the claims, are intended to specify the presence of stated features, integers, components, or steps, but they do not preclude the presence or addition of one or more other features, integers, components, steps, or groups thereof. Also the words, “maximize” and “minimize” as used herein include increasing toward or approaching a maximum and reducing toward or approaching a minimum, respectively, even if not all the way to an absolute possible maximum or to an absolute possible minimum.

What is claimed is:

1. Switch-mode power supply apparatus comprising:
an electric circuit comprising a power input, a power output, and inductor positioned in series between the power input and the power output, an active switch positioned in series with the inductor to provide a switch-node that connects the active switch and the inductor, and bypass switch means connected between the switch-node and ground in parallel to the inductor for providing a current path between the inductor and ground when the active switch is turned off; and
switch control means for turning the active switch on and off periodically, including pulse width modulation control means for imposing a duty cycle on the switch to produce a desired output voltage at the power output, and switch-node feedback means for providing feedback from the switch-node to the pulse width modulation control means to maintain the desired output voltage.

2. The switch-mode power supply apparatus of claim 1, wherein the bypass switch comprises a diode.

3. The switch-mode power supply apparatus of claim 1, wherein the switch control means includes comparator means for receiving the feedback from the switch-node, comparing the feedback from the switch node to a reference, and modulating the pulse width of a switch control signal to maintain voltage at the switch-node at a level that bears a desired relationship to the reference.

4. The switch-mode power supply apparatus of claim 3, wherein the switch control means includes hysteresis for providing the switch control signal with an oscillating duty cycle that causes oscillation of the switch-node voltage and for adjusting the pulse width modulation to maintain the oscillating switch node voltage between high and low thresholds that produce the desired output voltage.

5. The switch-mode power supply apparatus of claim 4, wherein the comparator means includes a pair of transistors arranged in differential configuration.

6. The switch-mode power supply apparatus of claim 5, including positive feedback means for creating the hysteresis in the comparator thresholds.

7. The switch-mode power supply apparatus of claim 4, wherein the comparator means includes a Schmidt trigger.

8. The switch-mode power supply apparatus of claim 4, including current sense means for monitoring load current through the power output and providing a signal related to the output load current to the switch control means to cause compensation for output voltage droop.

9. The switch-mode power supply apparatus of claim 4, including means for sampling input voltage and for compensating for output voltage variations that result from input voltage variations.

10. A method of pulse width modulation for controlling output voltage in a switch-mode power supply circuit that includes an inductor between a power input and a power output and an active switch connected via a switch-node to the inductor for imposing a duty cycle to control the output voltage, comprising:
generating a switch control signal that includes pulse width modulation for imposing an on-off duty cycle on the active switch to produce a desired output voltage; and obtaining feedback of voltage at the switch-node as indicative of the output voltage, and adjusting the pulse width modulation of the control signal to maintain the voltage at the switch node at a desired level to produce the desired output voltage.

11. The method of claim 10, including varying the pulse width modulation in an oscillatory manner to oscillate the voltage at the switch node between high and low thresholds that results in the desired output voltage.

12. The method of claim 11, including connecting a capacitor between the switch-node and a low impedance point in the circuit, and controlling the voltage across the capacitor between a high threshold and a low threshold, that results in the desired output voltage.

13. The method of claim 12, including using a comparator to compare the voltage across the capacitor to a reference voltage and to output the switch control signal to maintain the voltage across the capacitor in a relationship to the reference voltage that results in the desired output voltage.

14. The method of claim 13, wherein the comparator has high and low thresholds that cause change of state of the switch control signal between high and low states in response to input from the switch-node feedback signal reaching either the high or the low threshold so that the duty cycle varies in a manner that causes the voltage at the switch-node to oscillate between a high and low imposed by the comparator.

15. The method of claim 14, including providing the comparator with hysteresis in the thresholds.

16. The method of claim 15, wherein the comparator includes a Schmidt trigger.

17. The method of claim 15, including sensing and monitoring the output current when the output is connected to a load, creating a signal that is related to the output load current, and applying the signal to the comparator with the switch-node feedback to cause the comparator to produce a pulse width modulation of the switch control signal to impose a duty cycle that compensates for output voltage droop.

18. The method of claim 15, including sampling the input voltage, producing a signal related to the input voltage of a magnitude that, when applied to the comparator with the switch-node feedback, causes the comparator to produce the switch control signal with a pulse width modulation that imposes a duty cycle that compensates for variations in the output voltage that results from variations in the input voltage.
